(19) United States
(12) Patent Application Publication
(10) Pub. No.: US 2006/0006644 A1
(43) Pub. Date: Jan. 12, 2006

(54) Hose assembly utilizing heat shrink

(75) Inventor: Scott M. Roberts, Asheville, NC (US)

Correspondence Address: FITZPATRICK CELLA HARPER & SCINTO, 30 ROCKEFELLER PLAZA, NEW YORK, NY, 10112, US

(73) Assignee: CRANE RESISTOFLEX

(21) Appl. No.: 11/171,931

(22) Filed: Jun. 30, 2005

Related U.S. Application Data
(60) Provisional application No. 60/584,278, filed on Jun. 30, 2004.

(51) Int. Cl. F16L 33/00

(52) U.S. Cl. 285/242

(57) ABSTRACT

In manufacturing a hose, a liner composed of a polymeric material is provided, as is a fitting having a plurality of barbs. The barbs are covered with a fluoropolymer heat shrink tube so that the penetration depth and sharpness of the barbs are reduced. Then, the fitting is crimped onto the hose.

### CROSS-REFERENCE TO RELATED APPLICATION

This application claims the benefit of U.S. provisional application No. 60/584,278, filed Jun. 30, 2004, which is incorporated by reference in its entirety, as if fully set forth herein.

### BACKGROUND OF THE INVENTION

1. Field of the Invention

This invention relates generally to hoses and tubular conduits, and more particularly to hoses which have a thin liner made of a polymeric material, particularly of a fluoropolymer. This invention also relates to methods for making the same.

2. Related Art

Conduits and hoses are essential components of many apparatuses in a wide variety of fields, for example, in biotechnical applications, pharmaceuticals, medicine, etc. Such hoses typically have liners made of a fluoropolymer, e.g., ethyltetrafluoroethylene (ETFE), fluorinated ethylene propylene (FEP), hexafluoropropylene (HFP), perfluoroalkozyl (PFA), or polytetrafluoroethylene (PTFE). The liner may be composed of other suitable fluoropolymers, or a mixture of two or more fluoropolymers, and is often quite thin.

In manufacturing and assembling such hoses, at least one end fitting is crimped onto the hose after the ferrule of the fitting is inserted into the hose. However, one drawback to this technique is that because of the thinness of the fluoropolymer liner of the hose, when a fitting is crimped onto the hose the liner can be cut and split open, since the barbs or teeth on the hose ferrule can actually be deeper than the liner is thick. As a result, the integrity of the internal liner of the hose can be compromised. On the other hand, if the fittings are not crimped on with sufficient force, a fitting may inadvertently be pulled off of the hose assembly. Making the liner thicker is typically not a satisfactory solution to this problem, since a thinner liner is advantageous in that it increases hose flexibility.

There exists, therefore, a need for a hose and corresponding methods of making the same which overcome these and other drawbacks associated with prior art hoses and methods. In particular, there is a need for a need for a hose and corresponding methods of making the same which enable fittings to be crimped on with sufficient force and yet without compromising the internal liner of the hose.

### SUMMARY OF THE INVENTION

Accordingly, it is an object of the present invention to overcome the above-described conventional problems associated with prior art hoses and methods of making the same by providing a hose in which the fittings can be crimped on with sufficient force but without compromising the internal liner of the hose. It is also an object of the present invention to provide such a hose which is relatively simple to manufacture.

One aspect of the present invention is a fitting that includes at least one barb, and a heat shrink, applied to the at least one barb. The heat shrink may be a fluoropolymer.

Another aspect of the present invention is a fitting that includes a plurality of barbs, and a preferably fluoropolymeric heat shrink layer covering the barbs.

Another aspect of the present invention is a method of manufacturing a fitting that includes the steps of providing a fitting having at least one barb, and applying a preferably fluoropolymeric heat shrink tube or similar layer to the at least one barb.

Yet another aspect of the present invention is a method of manufacturing a fitting that includes the steps of providing a fitting having a plurality of barbs, and covering the barbs with a preferably fluoropolymeric heat shrink tube or layer so that the penetration depth and sharpness of the barbs are reduced.

Yet another aspect of the present invention is a method of manufacturing a hose that includes the steps of providing a liner composed of one or more fluoropolymers, providing a fitting having at least one barb, applying preferably fluoropolymeric heat shrink layer to the at least one barb, and crimping the fitting onto the hose.

Still another aspect of the present invention is a method of manufacturing a hose that includes the steps of providing a liner composed of a polymeric material, providing a fitting having a plurality of barbs, covering the plurality of barbs with a fluoropolymer heat shrink tube so that the penetration depth and sharpness of the barbs are reduced, and crimping the fitting onto the hose.

Still another aspect of the present invention is a hose that includes a liner composed of a fluoropolymer, and a fitting having at least one barb and being crimped onto the hose, in which fluoropolymer heat shrink is applied to the at least one barb prior to the fitting being crimped onto the hose.

Still another aspect of the present invention is a hose that includes a liner composed of a polymeric material, and a fitting having a plurality of barbs and being crimped onto the hose, in which the barbs are covered with a fluoropolymer heat shrink tube prior to the fitting being crimped onto the hose so that the penetration depth and the sharpness of the barbs are reduced.

### BRIEF DESCRIPTION OF THE DRAWINGS

These and other aspects of the invention will be more clearly understood by reference to the following detailed description of exemplary embodiments in conjunction with the accompanying drawings, in which:

FIG. 1 is a perspective view of a fitting having barbs, with a heat shrink tube placed thereon, according to the present invention;

FIG. 2 illustrates a perspective view of the fitting shown in FIG. 1 after application of the polymer to the barbs; and

FIG. 3 illustrates a cross-section of the fitting shown in FIG. 2.

### DETAILED DESCRIPTION OF THE PREFERRED EMBODIMENTS

The invention will next be described with reference to the preferred embodiments; however, it will be clear to those skilled in the art that various modifications, additions, and subtractions can be made without departing from the spirit or scope of the claims.

In a preferred embodiment of the present invention, a hose assembly and corresponding method of making the same are provided, in which a heat shrink tube is utilized. In that embodiment, the hose barbs are covered with a thin fluoropolymer heat shrink layer. As described above, covering the barbs with such a layer has a number of advantages, including that the depth of the barbs is reduced, and the barbs become less sharp, which protects the liner from being cut or split by the barbs when the fitting is secured to the hose. The inventor has found that a fitting with this structure can be crimped to the hose with sufficient force without compromising the internal liner of the hose.

It is noted that the terms “barbs” and “teeth” are used herein broadly to include not only sharp points, but also surfaces having ridges, raised or protruding edges, and including (as in the preferred embodiment) surfaces which are annular in shape, and the like, and other shapes that are capable of playing a similar role in helping to secure the fitting to the hose.

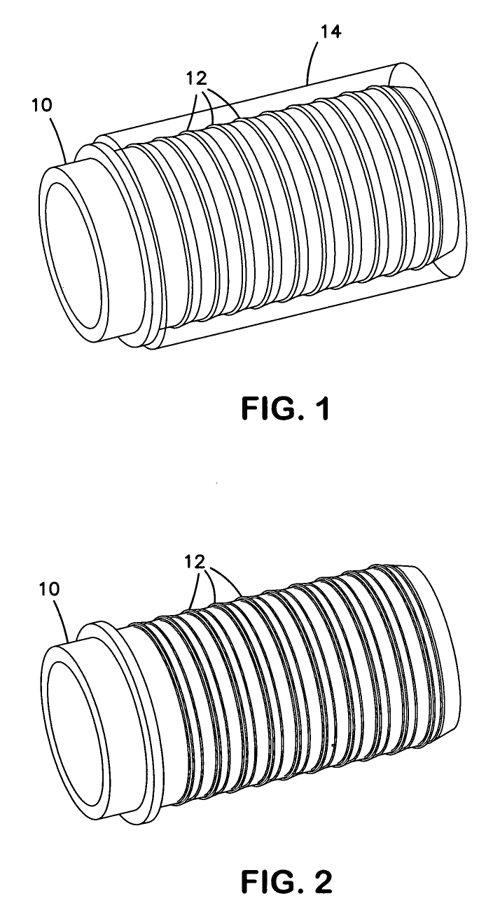

FIG. 1 shows a perspective view of a fitting 10 having barbs 12. According to the present invention, a thin-walled heat shrink tube 14 is placed over the barbs 12 on the fitting ferrule 10. Heat is then applied and the tube 14 is shrunk snugly over the barbs 12.

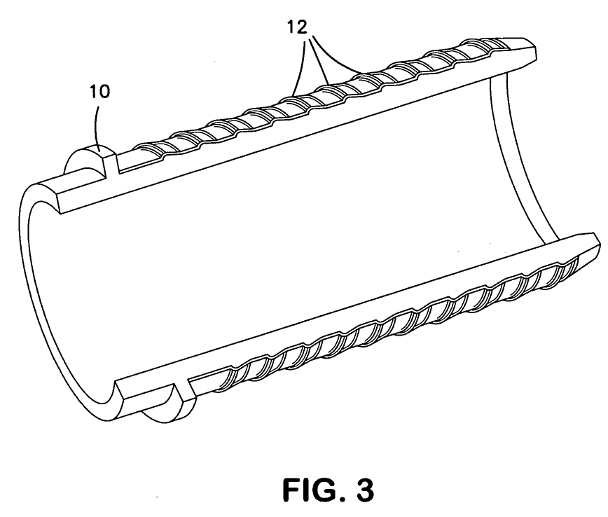

FIG. 2 illustrates a perspective view of the fitting ferrule 10 after the barbs 12 have been shrunk by the heat shrink tube 14, while FIG. 3 illustrates a perspective view of a cross-section of the fitting ferrule 10 shown in FIG. 2. As can be seen, the barbs are ‘blanketed’ with the fluoropolymer layer, and thus the relatively sharply radiused portions of the barbs are covered by a smoother, less sharp shape in the fluoropolymer layer. Once the heat shrink tube 14 has been applied, the fitting 10 is ready to be inserted into a hose, and a collar is crimped in known fashion over the hose in order to attach the fitting 10 by way of compressive forces. In this way, hose fittings can be joined to a fluoropolymer-lined hose, even if the fluoropolymer liner is extremely thin-walled.

Although preferred embodiments have been described herein using fluoropolymer heat shrink, such as fluorinated ethylene propylene (FEP), the heat shrink may be materials other than a fluoropolymer. Furthermore, in preferred embodiments, the temperature required to achieve shrinking may be in the range of 410-430 degrees Fahrenheit, although the requisite temperature could be outside this range, depending on the materials used. Heat shrink may be applied using a heat gun, although other methods, such as utilizing an oven, may provide more uniform heat shrink. Again, the fluoropolymer coating on the barbs can be applied in other forms besides a tube, although the use of a tube is particularly convenient for the manufacturing process, and while it is contemplated that the layer will be a complete layer as shown in the Figures, an approach in which the fluoropolymer does not form a complete layer covering all the barbs (or covering only the sharper portions of the barbs), is also within the scope of the invention.

Liners used with the present invention are broadly conceived, and may be made of a fluoropolymer as explained, or of an elastomeric material, for example. Hose carcasses used with this invention may be made of rubber; for example, the hose may be covered with ethylene propylene diene monomer (EPDM), which is a synthetic rubber that tends to be highly flexible, stable, and long lasting. Hose carcasses used with this invention are also broadly conceived, and may include carcasses made of other elastomers or even polymers in place of rubber, or may include mechanical sleeves or braids (e.g., stainless steel).

The invention has been described in connection with certain exemplary embodiments. However, it should be clear to those skilled in the art that various modifications, additions, subtractions, and changes in form and details may be made to those embodiments without departing from the spirit or scope of the invention as set forth in the claims below.

What is claimed is:

1. A fitting, comprising:
at least one barb; and
a fluoropolymer heat shrink, applied to the at least one barb.

2. A fitting, comprising:
a plurality of barbs; and
a fluoropolymer heat shrink tube covering the barbs.

3. A method of manufacturing a fitting, comprising the steps of:
providing a fitting having at least one barb; and
applying a fluoropolymer heat shrink to the at least one barb.

4. A method of manufacturing a fitting, comprising the steps of:
providing a fitting having a plurality of barbs; and
covering the barbs with a fluoropolymer heat shrink tube so that a penetration depth and a sharpness of the barbs are reduced.

5. A method of manufacturing a hose, comprising the steps of:
providing a liner composed of one or more fluoropolymers;
providing a fitting having at least one barb;
applying fluoropolymer heat shrink to the at least one barb; and
crimping the fitting onto the hose.

6. A method of manufacturing a hose, comprising the steps of:
providing a liner composed of a polymeric material;
providing a fitting having a plurality of barbs;
covering the plurality of barbs with a fluoropolymer heat shrink tube so that a penetration depth and a sharpness of the barbs are reduced; and
crimping the fitting onto the hose.

7. A hose, comprising:
a liner composed of a fluoropolymer; and
a fitting having at least one barb and being crimped onto the hose,
in which fluoropolymer heat shrink is applied to the at least one barb prior to the fitting being crimped onto the hose.

8. A hose, comprising:
a liner composed of a polymeric material; and
a fitting having a plurality of barbs and being crimped onto the hose,
in which the barbs are covered with a fluoropolymer heat shrink tube prior to the fitting being crimped onto the hose so that a penetration depth and a sharpness of the barbs are reduced.
